(19) United States
(12) Patent Application Publication
(10) Pub. No.: US 2010/0081544 A1
(43) Pub. Date: Apr. 1, 2010

(54) METHOD AND APPARATUS FOR SHIFTING AN AUTOMATIC TRANSMISSION

(76) Inventor: Gordon R. Warner, Orem, UT (US)

Correspondence Address: ANGUS C. FOX, III, 4093 N. IMPERIAL WAY, PROVO, UT, 84604-5386, US

(21) Appl. No.: 12/569,804

(22) Filed: Sep. 29, 2009

Related U.S. Application Data
(60) Provisional application No. 61/101,021, filed on Sep. 29, 2008.

(51) Int. Cl. F16H 59/74

(52) U.S. Cl. 477/121

(57) ABSTRACT

This invention automatically shifts the automobile from DRIVE to NEUTRAL when the gas accelerator pedal is fully released. This procedure not only maximizes energy input from gravity on downgrades, but also helps conserve the kinetic energy of moving vehicle in at least three ways. Firstly, rotating and reciprocating friction of the engine is minimized by bringing the engine to idle when power input from the engine is not needed. Secondly, energy losses from pumping lubricating oil and coolant at much higher pressures throughout the engine during high-speed operation are reduced. Thirdly, and most significantly, the compression braking effect of an internal combustion engine at low throttle settings—whereby kinetic energy from the moving vehicle is converted to heat during each energy-consuming compressing stroke—is eliminated.

This application has a priority date based on Provisional Patent Application No. 61/101,021, which has a filing date of Sep. 29, 2008, and bears the same title.

### FIELD OF THE INVENTION

The present invention relates, generally, to automotive drive trains and, more particularly, to shifting methods for automatic transmissions.

### BACKGROUND OF THE INVENTION

Four major fields of engineering design have played pivotal roles in the development of the automobile: engine design; drive train design; suspension design; and brake design. As the focus of this application involves shifting methods for automatic transmissions, a short history of transmissions is in order. Delivery of power from an internal combustion engine to the wheels of a road-going vehicle has been a continuing challenge for well over a century. The drivetrain of such a vehicle is the system that transmits an engine's rotational energy to the wheels, and is generally considered to includes all of the hardware from the power take-off end of the engine crankshaft to the hubs on which the powered wheels of the vehicle are mounted. When it comes to automotive technology, there are exceedingly few new ideas, just progressively successful adaptations of old ones.

The heart of the drive train is the transmission. Because internal combustion engines—particularly spark ignition engines—develop their torque over a relatively narrow speed range, several gears are needed to reach useful road speeds. Steam engines and electric motors can be used in vehicles without a transmission.

The modern manual transmission was invented by Louis-Rene Panhard and Emile Levassor (both Frenchmen) in 1894. Cars of the time transmitted engine power to the wheels in a simple fashion that was similar to power drives used on water- and steam-powered industrial equipment. The engine drove a set of bevel reduction gears that drove a shaft and pulley. Leather belts coupled the pulley to two geared wheels on an axle, one of which was considerably smaller in diameter than the other. The small-diameter geared wheel was used to accelerate the vehicle by meshing with a ring gear on one of the driving wheels. The large-diameter geared wheel then took over to achieve a top speed of some 20 mph. Whenever the vehicle came to steep hills, the driver would come to a dead stop so that he could reengage the small-diameter wheel.

In 1895 Panhard and Levassor introduced an automobile that was revolutionary, both in terms of transmission design and the drivetrain layout. Unlike cars of the day, it had a drivetrain layout much like the rear-drive automobiles that have been manufactured ever since. It had a vertically-oriented, front-mounted engine in the front of the vehicle that drove the rear wheels through a clutch, a 3-speed sliding-gear manual transmission and a chain-driven axle, in that order. The only missing modern features—a differential-equipped, live rear axle and a metal driveshaft—were added three years later, in 1898 by Louis Renault. The differential was actually an adaptation of a 1893 invention by an American named C. E. Duryea. The differential cured the problem of rapid tire wear caused by both rear wheels on a “dead” axle rotating at the same speed as the vehicle negotiated turns.

The Panhard-Levassor sliding gear-manual transmission, which had been adopted by most automobile manufacturers by 1904, remains in use even today. The most significant improvement in sliding-gear manual transmissions was a synchronization system introduced by Cadillac in 1928, which allowed gears to be changed without grinding, by causing the new gear to attain the rotational speed of the gear that is being relinquished before meshing occurs. The “synchromesh” system used in all modern manual transmissions was patented by Porsche and introduced on the Porsche 356 1500S in late 1952. In the Porsche system, the teeth of the gear sets are always engaged. Multiple shifter bodies are employed to disengage one gear set and engage another. A brass clutch having an inner conical surface moves against an outer conical surface on the new gear, causing it to speed up before the shifter body engages it.

Henry Ford eschewed the sliding-gear transmission in favor of foot pedal-controlled planetary gearset for his 1908 Model T Ford. It had a central “sun” gear surrounded by three “planet” gears, and provided two forward speeds with reverse. Today, planetary gearsets are found in all automatic transmissions except those of the constant variable (CVT) type.

In 1930, Walter Wilson introduced the Wilson Preselector transmission, which employed four individual planetary gear sets. In order to shift this transmission, the driver preselected a desired gear ratio by moving a small lever on the steering column. The driver would then engage the preselected gear by depressing a foot pedal. This caused a camshaft to disengage one gearset and simultaneously engage another.

The automatic transmission was an entirely American development. The first automatic was invented in 1904 by the Sturtevant brothers of Boston. It provided two forward speeds that were engaged and disengaged by the action of spring-loaded centrifugal weights without need for a foot-operated clutch. As engine speed increased, the weights swung out and, first, engaged a low-gear band. As engine speed increased still further, a high-gear band was engaged. Similar in concept to a centrifugal clutch, poor design rendered the unit was prone to failure, as the weights often flew apart.

In 1934, the Reo Motorcar Company introduced an automatic called the Reo Self-Shifter. It was actually two serially-coupled transmissions. One of the transmissions was shifted automatically as a function of the car's speed using a centrifugal, multi-disc clutch. The second transmission was shifted manually to provide both low and high-range gearing.

The Automatic Safety Transmission (AST) was an early tangential offspring of Hydra-Matic transmission development at General Motors Corporation. The short-lived AST, which was offered by Oldsmobile from 1937 to 1939 and by Buick only in 1938, was a semi-automatic transmission having a conventional clutch for shifting the transmission between a reverse gear and the forward gears. When the forward gears—which consisted of two serially coupled, hydraulically-operated planetary gearsets—were selected, the transmission automatically shifted between the two speeds, designated LOW and DRIVE, as a function of vehicle speed.

All modern automatic transmissions, other than those of the constant-variable type, utilize some type of fluid coupling between the engine crankshaft and the gear sets. Chrysler Corporation was the first to perfect the fluid coupling in 1937. However, its first use in 1941, was as a replacement for a friction clutch on a manual transmission, which was marketed as Fluid Drive.

The original General Motors Hydra-Matic transmission, the development of which was completed in 1938, was a milestone in transmission technology. Having four forward speeds and reverse, it incorporated three hydraulically-operated, planetary gearsets and a fluid coupling. Unlike the torque converters of modern automatics, the fluid coupling did not couple the gearsets to the engine crankshaft. This first fully automatic transmission, dubbed “Hydra-Matic Drive,” incorporated a parking pawl when the selector was placed in reverse with the engine off, although there was no separate Park position. The transmission went into production in May 1939 for use later that year on some 1940 model-year Oldsmobiles. At the time, the automatic option added 57 dollars to the price of the vehicle. By the time it became an option for Cadillacs in 1941, its popularity had enabled GM to more than double the option price to 125 dollars. Almost 200,000 Hydra-Matic Drive equipped vechiles had been sold by the time passenger car production was halted for wartime production in February 1942. During the war, the Hydra-Matic was used in a variety of military vehicles, including the M5 Stuart tank (where 2 of them were mated to twin Cadillac V8 engines) and the M24 Chaffee light tank. The extensive wartime service greatly improved the postwar engineering of the transmission, later advertised as “battle-tested.”

By 1948, the automatic transmission had evolved into the hydraulic torque converter—that is still used extensively today—coupled to a planetary geartrain. GM's Buick Motor Division was the first to use the torque converter. The 1948 Buick Dynaflow, as it was called, was a two-speed semi-automatic that normally started in high gear, and used a torque converter for torque multiplication. Although it could be manually shifted into low gear, it would not subsequently automatically upshift to high gear. Though based on the Dynaflow model, all modern automatic transmissions with planetary gearsets increase efficiency by shifting automatically between planetary gearsets. In 1950, Chevrolet introduced its two-speed, fully-automatic Powerglide transmission, which would be installed in various GM automobiles up until 1973. Ford Motor Company also introduced the Borg Warner-designed three-speed Fordomatic/Merc-O-Matic in 1950. Chrysler introduced the Chrysler M-6 Torque Converter semi-automatic the following year.

The efficiency of automatic transmissions has improved dramatically over the past half century. Efficiency has been achieved primarily through the use of a greater number of forward speeds and a reduction in torque converter slippage through the use of a torque converter lockup clutch. Although four forward speeds have become the minimum specification for automatic transmissions, five-and six-speed automatic transmissions are becoming the standard for the general market. Mercedes Benz automobiles are being equipped with seven-speed automatics, and BMW and Lexus models will soon be available with eight-speed automatics. Torque converter lockup has likely made a greater contribution to improved fuel efficiency than an increase in the number of forward speeds by dramatically reducing the amount of heat generated by the transmission after cruise has been achieved. Surprising, the first automotive application of the lock-up principle was Packard's Ultramatic transmission, introduced in 1949, which locked up the torque converter at cruising speeds, and unlocked it for improved acceleration when the throttle was floored, as well as when the vehicle slowed down. This feature was also present in some Borg-Warner transmissions produced during the 1950's. However, it fell out of favor in subsequent years due to its additional complexity and cost. In the late 1970's lock-up clutches started to reappear in response to demands for improved fuel economy, and are now nearly universal in automotive applications.

### SUMMARY OF THE INVENTION

In past years, there was never any apparent reason to manually shift a vehicle's automatic transmission from DRIVE to NEUTRAL, and then back again into Drive. In fact, owner's manuals for vehicles with early automatic transmissions typically cautioned drivers of those vehicles not to do so, as there was concern that damage would occur to the transmission and torque converter. There was also the justifiable concern that the driver might inadvertently engage REVERSE while attempting to engage NEUTRAL, thereby causing almost certain damage to the transmission. In addition, until the advent of disc brakes, it was downright dangerous to decouple the engine from the drive train while traveling at a high rate of speed, as the compression braking effect of the engine would be entirely eliminated. As drum brakes were notorious for fading and losing nearly all of their stopping ability—often after only a single panic stop from high speed, or while braking on a downgrade—elimination of the compression braking effect could conceivably have had fatal consequences.

Although automatic transmissions in modern automobiles can generally be manually shifted from DRIVE to NEUTRAL and back again to DRIVE at any speed without causing damage to the transmission, there has generally been no apparent reason to engage in the procedure. Disc brakes, which have become standard equipment on at least the front wheels of all new vehicles, have eliminated the need for compression braking in all but the most extreme situations where a heavily laden vehicle is descending an exceptionally steep grade. In addition, there is still the possibility of damage occurring to the transmission from inadvertently shifting into REVERSE instead of NEUTRAL.

The present invention is intended to further improve the efficiency of automatic transmissions by decoupling the engine from the drivetrain whenever the throttle is fully released, as determined by the position of either the accelerator pedal or the cruise control servo. Decoupling of the engine from the transmission and the rest of to drivetrain is accomplished by a transmission disengagement servo, which shifts the automatic transmission from DRIVE into NEUTRAL whenever the engine's throttle is fully released. Full release is determined by a throttle position sensor, which may be a microswitch associated with the accelerator pedal or throttle linkage. In a fully electrical, control-by-wire system, full throttle release can determined by an electrical signal value within the control-by-wire system. In any case, when the condition of full throttle release is detected, a transmission disengagement servo is activated, which shifts the transmission from DRIVE into NEUTRAL. When a subsequent opening of the throttle is detected by similar means, a transmission engagement servo is activated, which shifts the transmission back into DRIVE from NEUTRAL. Thus, whenever the throttle is fully released, the engine is decoupled from the transmission and the rest of the drivetrain so that the vehicle can coast and the engine can return to its idle setting. This procedure not only maximizes energy input from gravity on downgrades, but also helps conserve the kinetic energy of moving vehicle in at least three ways. Firstly, rotating and reciprocating friction of the engine is minimized by bringing the engine to idle when power input from the engine is not needed. Secondly, energy losses from pumping lubricating oil and coolant at much higher pressures throughout the engine during high-speed operation are reduced. Thirdly, and likely most significantly, the compression braking effect of an internal combustion engine at low throttle settings—whereby kinetic energy from the moving vehicle is converted to heat during each energy-consuming compressing stroke—is eliminated. The invention is somewhat analogous to a bicycle having a freewheel coupling of the chain to the hub of the rear wheel. Whenever a rider is coasting, his legs are operatively decoupled from the bicycle drivetrain, thereby enabling the rider's legs to remain stationary while coasting. Bicycles built for banked circular tracks operate much like conventional automobiles. The rider's legs are always operatively coupled to the spinning rear wheel, as there is no freewheel coupling of the chain to the hub of the rear wheel. The tracks are essentially flat, and track racers must apply power to the pedals constantly during a race. As there is no reason, or opportunity, to coast during a race, a freewheel coupling of the chain to the rear hub would simply add a small amount of undesirable weight to the bicycle, which would slow acceleration during sprints.

The invention can also incorporate a synchronization feature so that when the automatic transmission is shifted from NEUTRAL to DRIVE while the vehicle is moving, the engine and torque converter rotational speeds are synchronized to the proper transmission input speed for the gear which will be selected when DRIVE is reengaged. Synchronization of the rotational output and input speeds help smooth the transitions from a free-wheeling state to an engine-engaged state. Thus, control logic is provided that monitors both engine speed and automatic transmission input speeds, and determines the appropriate gear for any given speed. When the throttle pedal is depressed after a period of free-wheeling in NEUTRAL, DRIVE is automatically engaged after the engine is brought to the appropriate engine speed for engagement with the transmission by a throttle servo coupled to the control logic. This procedure not only reduces stress on the torque converter and transmission components, but also smooths the re-engagement of the engine with the transmission.

Another feature of the invention is the ability to override the free-wheeling function by manually shifting the automatic transmission into LOW range. At this setting, the servo, which effects disengagement of the engine and the transmission while coasting, is deactivated.

### ADVANTAGES OF THIS INVENTION AND TEST RESULTS

The invention has been shown during testing to achieve significant improvement in fuel efficiency. The effect of gravity on a vehicle that is negotiating a downgrade and conservation of a vehicle's inertia, regardless of the grade, is maximized by automatically shifting the vehicle's automatic transmission into NEUTRAL whenever the accelearator pedal is fully released. Test results for a 1997 Subaru Legacy on Jul. 31, 2008 in light traffic on Highway 15 between Provo, Utah and Salt Lake City, Utah, with the air conditioner in use, resulted in an increase from 24.9 to 43.6 miles per gallon. The same tests performed with the air conditioner off resulted in an increase from 34.7 to 57.5 miles per gallon. Both of these results represent a significant increase in fuel efficiency that validates the usefulness of the invention.

### BRIEF DESCRIPTION OF THE DRAWINGS

FIG. 1 is a schematic diagram of a system for automatically shifting a vehicle's automatic transmission from DRIVE into NEUTRAL whenever the vehicle's accelerator pedal is fully released, and automatically reengaging DRIVE when the accelerator pedal is subsequently depressed.

### PREFERRED EMBODIMENT OF THE INVENTION

The apparatus for shifting a vehicle's automatic transmission from DRIVE into NEUTRAL when the vehicle's accelerator pedal is fully released and reengaging DRIVE when the accelerator pedal is subsequently depressed will now be described in detail with reference to the attached drawing figure.

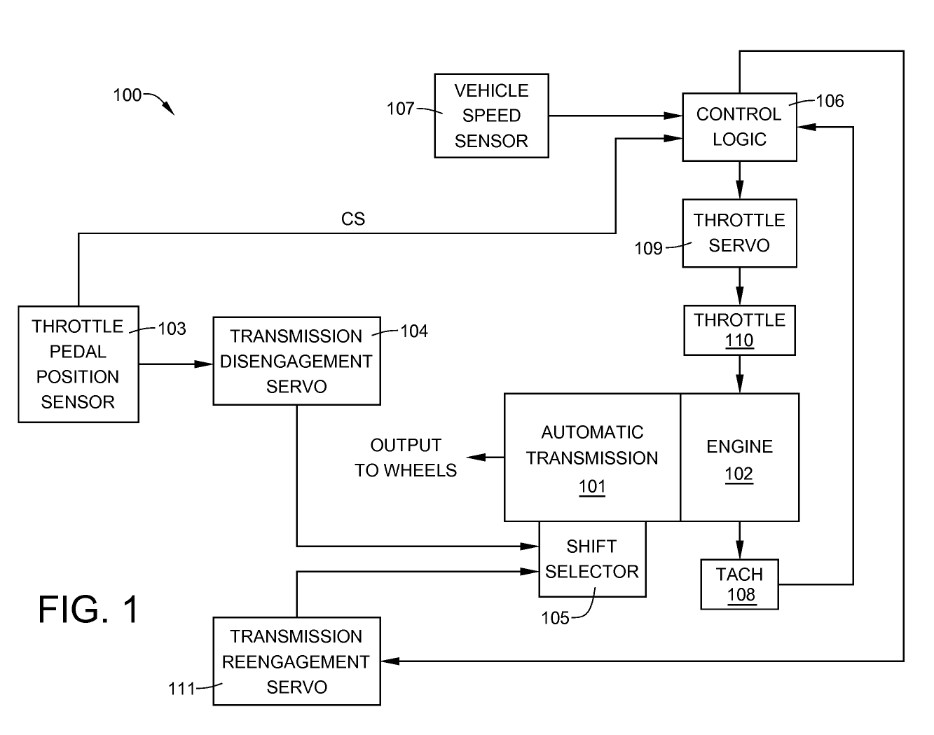

Referring now to FIG. 1, an automatic transmission 101 is coupled to an internal combustion engine 102. It should be understood that connection between the accelerator pedal and the throttle is not direct, but rather controlled electronically. When a throttle position sensor 103 detects full release of the accelerator pedal (not shown), a transmission disengagement servo 104 is activated, thereby causing the transmission shift selector 105 to shift the automatic transmission from DRIVE into NEUTRAL. Conversely, when the throttle position sensor 103 detects a subsequent depression of the accelerator pedal, it sends a control signal CS to a control logic module 106, which also receives a vehicle speed input from vehicle speed sensor 107 and an engine speed input from tachometer 108. The control logic module 106 determines an appropriate engine speed for synchronization to transmission input speed and sends a control signal to a throttle servo module 109, which increases the setting of the engine throttle 110 until synchronization of engine speed with transmission input speed is achieved. Once synchronization is achieved, the control logic module 106 sends a control signal to a transmission reengagement servo 111, which shifts the transmission back again into DRIVE. An appropriate forward gear in the DRIVE range is determined by the control logic module 106, as a function of both vehicle speed and rate of deceleration at the time of reengagement. When reengagement is effected, the appropriate forward gear is selected. Transmission selection of DRIVE and NEUTRAL may be cyclical or sequential so that the transmission disengagement servo 104 and the transmission reengagement servo 111 may be the same device. Likewise, although electrically-powered servos, whether having electric motors or solenoids, are presently deemed to be preferred embodiments for mechanical actuation, other types of servos, such as pressurized pneumatic, vacuum pneumatic and hydraulic servos may also be used with success.

Although only a single embodiment of the apparatus for shifting a vehicle's automatic transmission from DRIVE into NEUTRAL when the vehicle's accelerator pedal is fully released and reengaging DRIVE when the accelerator pedal is subsequently depressed has been heretofore described, it should be obvious to those having ordinary skill in the art that changes and modifications may be made thereto without departing from the scope and the spirit of the invention as hereinafter claimed.

What is claimed is:

1. A method of shifting an automatic transmission comprising the steps of:
automatically shifting the transmission from DRIVE to NEUTRAL when the accelerator pedal is fully released; and
automatically shifting the transmission from NEUTRAL to DRIVE when the accelerator pedal is subsequently depressed.

2. The method of claim 1, wherein automatically shifting the transmission from DRIVE to NEUTRAL is executed by a disengagement servo in response to a throttle position sensor detecting full release of the accelerator pedal.

3. The method of claim 2, wherein automatically shifting the transmission from NEUTRAL to DRIVE is executed by a reengagement servo in response to the throttle position sensor detecting a depressing of the accelerator pedal.

4. The method of claim 2, wherein said disengagement servo and said reengagement servo are the same device.

5. The method of claim 3, wherein said disengagement servo and said reengagement servo are selected from the group consisting of electric servo motors, solenoids, servos operated by pressurized air, vacuum-operated servos, and hydraulically-operated servos.

6. The method of claim 1, wherein shifting of the transmission from NEUTRAL into DRIVE is accomplished with a concurrent synchronization of engine rotational speed with transmission rotational input speed.

7. The method of claim 6, wherein synchronization of engine rotational speed with transmission rotation input speed is effected by a throttle servo coupled to a control logic module.

8. The method of claim 6, wherein shifting of the transmission from NEUTRAL into DRIVE is further accomplished with selection of a forward gear in the DRIVE range appropriate for vehicle speed and a rate of vehicle deceleration at the time of reengagement.

9. The method of claim 1, wherein the automatic shifting the transmission from DRIVE to NEUTRAL when the accelerator pedal is fully released can be overridden by the vehicle operator manually shifting the automatic transmission gear selector into its LOW range.
